(19) United States
(12) Patent Application Publication
(10) Pub. No.: US 2018/0354706 A1
(43) Pub. Date: Dec. 13, 2018

(54) SPRAYABLE MAPLE SYRUP DISPENSER

(71) Applicants: Kyle Rood, Webster Groves, MO (US); Clint Matthews, Fenton, MO (US)

(72) Inventors: Kyle Rood, Webster Groves, MO (US); Clint Matthews, Fenton, MO (US)

(21) Appl. No.: 15/974,939

(22) Filed: May 9, 2018

Related U.S. Application Data
(60) Provisional application No. 62/658,954, filed on Apr. 17, 2018.
(60) Provisional application No. 62/632,816, filed on Feb. 20, 2018.
(60) Provisional application No. 62/503,630, filed on May 9, 2017.

(51) Int. Cl. B65D 83/00; B67D 1/12

(52) U.S. Cl. CPC B65D 83/0055; B67D 1/1277

(57) ABSTRACT

Bag-on-valve (“BOV”) systems adapted to dispense viscous liquids, particularly syrup, which ordinarily crystallize in the presence of atmospheric oxygen and thereby block the flow path from the bag to the exterior of the container. The present systems utilize a BOV flow path diameter effective to inhibit crystallization-based blockage. This facilitates storage of syrups at room temperature without needing refrigeration, and allows control over the dispensing amount through the use of a spray actuator. Methods for filling a BOV system with viscous product include a step to remove remnant product in the valve stem which may inhibit initial discharge. Such methods include exposure to a water source to dislodge and remove or dilute the remnant for evaporation or expulsion during initial discharge.

### CROSS-REFERENCE TO RELATED APPLICATIONS

This application claims benefit of U.S. Provisional Patent Application No. 62/658,954, filed Apr. 17, 2018, U.S. Provisional Patent Application No. 62/632,816, filed Feb. 20, 2018, and U.S. Provisional Patent Application No. 62/503,630, filed May 9, 2017. The entire disclosures of all three of these documents are hereby incorporated herein by reference.

### BACKGROUND OF THE INVENTION

### Field of the Invention

This disclosure is related to the field of food storage and dispensing, and more particularly to systems, methods and devices for storing and dispensing maple syrup via a spray nozzle.

### Description of the Related Art

It has become increasingly popular for food flavoring to be dispensed via a volume-controlled means. For example, butter sprays are increasingly popular because the amount of butter dispensed can be carefully and mechanically controlled. This results in less utilization of butter, meaning the food receives less butter, and therefore, the consumer receives less fat. Additionally, less butter is wasted by sliding off of the food and accumulating on the dish, where it is not consumed and does not contribute to flavor. Such spray technologies have other advantages as well, such as sealing and containing the flavoring, which can prolong shelf life and prevent spoilage.

One challenge with spray delivering systems is that a propellant is needed. The propellant can alter the flavoring or texture of the food, and thus preferably is stored separately from the product to be dispensed. Also, if propellant is mixed with the food, it is no longer accurate to market the flavoring by asserting that it is 100% pure flavoring. Further, interactions between the flavoring and propellant can alter the taste profile or reduce the shelf life of the flavoring. Additionally, prior art aerosol systems often result in sub-optimal utilization of the flavoring, resulting in waste, because the entire volume of purchased flavoring cannot be used.

Dispensing maple syrup via a spray poses additional challenges, because maple syrup tends to crystalize easily. Maple syrup is generally made by tapping the trunks of certain types of maple trees and collecting the exuded sap. The sap is then processed by heating. As is well known in the art, when solutions are boiled, water evaporates and the solution becomes more concentrated. At a certain concentration, crystals begin to form. This is because when the solution reaches a concentration where no more sugar can be dissolved (i.e., too much water has been boiled out), the solution becomes super-saturated and some of the sugar will “fall out” of the solution via crystallization. The heating process evaporates most of the water content of the syrup, leaving concentrated syrup behind. The resulting maple syrup is essentially a super-saturated sugar solution. Simply leaving a container of maple syrup at room temperature for long enough will cause some of the sugar to crystalize. The weight of the syrup above applies pressure and increases the density of the maple syrup at the bottom of the container, resulting in crystallization at room temperature.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are systems, methods, and devices for dispensing maple syrup using a bag-on-valve delivery mechanism sometimes also referred to in the art as BOV. In such a system, the product to be dispensed is housed separately from the propellant that is used to dispense the product. This prevents pre-dispensation intermixing of the two components, improving taste, lengthening shelf life, and allowing the product to be sold as a 100% pure product, and allowing for more than 99% product utilization, reducing the waste found with both aerosolized dispensation systems and standard jarred or canned products.

Described herein, among other things, is an apparatus for dispensing a syrup comprising: a container having an interior side and having an opposing exterior side; a bag adapted to store syrup and having a fluid channel at an end thereof, the bag disposed in the hollow interior; a fluid communication path from the bag to the exterior; a valve disposed in the in fluid communication path, the valve having a closed position and an open position, the valve blocking the fluid communication path when in the closed position; and an actuator operable to cause the valve stem to be in the open position; wherein the fluid communication path has a diameter effective to inhibit syrup crystallization in the fluid communication path.

In an embodiment of the apparatus, the diameter is more than about 0.30 millimeters.

In another embodiment of the apparatus, the diameter is less than about 1.70 millimeters

In another embodiment of the apparatus, the apparatus further comprises a propellant disposed in the container between the bag and the interior side.

In another embodiment of the apparatus, the valve comprises a male valve and the actuator comprises a female actuator.

In another embodiment of the apparatus, the valve comprises a female valve and the actuator comprises a male actuator.

Also described herein, among other things, is a method for filling a bag-on-valve container for dispensing viscous liquids comprising: providing a bag-on-valve container system having a stem; providing a source containing product to fill the bag-on-valve system; providing a filling head adapted to fill the bag-on-valve system with product from the source; the filling head forming, through the stem, a fluid pathway from the source to the bag-on-valve system; filling the bag-on-valve system with product from the source through the formed fluid pathway; releasing the filling head from the bag-on-valve system, the releasing step causing an amount of product remnant to deposit in the stem; and removing the product remnant from the stem.

In an embodiment of the method, removing the product remnant from the stem comprises introducing a supply of water to the product remnant in the stem.

In a further embodiment of the method, introducing a supply of water to the product remnant in the stem comprises disposing the filled bag-on-valve system in a water bath.

In a further embodiment of the method, the filled bag-on-valve system is disposed in the water bath stem first.

In a further embodiment of the method, removing the product remnant from the stem further comprises removing the bag-on-valve system from the water bath after a predetermined amount of time.

In a further embodiment of the method, the predetermined amount of time is effective to dilute the product remnant to about the same viscosity as the water bath.

In a further embodiment of the method, removing the product remnant from the stem further comprises agitating the filled bag-on-valve system after the removing step.

In a further embodiment of the method, the water is above room temperature.

In a further embodiment of the method, introducing a supply of water to the product remnant in the stem comprises forceful injection of the water into the stem.

In a further embodiment of the method, introducing a supply of water to the product remnant in the stem comprises immersing the stem in a water bath for a predetermined amount of time.

In a further embodiment of the method, the predetermined amount of time is effective to dilute the product remnant to about the same viscosity as the water bath.

In a further embodiment of the method, the predetermined amount of time is effective to dilute the product remnant to a viscosity at which the product does not crystallize sufficiently to clog the stem.

In a further embodiment of the method, the predetermined amount of time is effective to dilute the product remnant to a viscosity at which the product evaporates.

In a further embodiment of the method, the product comprises a honey or syrup.

### BRIEF DESCRIPTION OF THE DRAWINGS

FIGS. 1A-1B depicts a bag-on-valve delivery system according to the present disclosure.

u depicts a maple syrup spray nozzle, including valve stem and actuator according to the present disclosure.

FIGS. 3A-3B depicts various embodiments of valve/actuator combinations according to the present disclosure.

FIGS. 4A-4B depicts an embodiment of an actuator having suitable dimensions for use in connection with the present disclosure.

FIGS. 5A-5B depicts an alternative embodiment of an actuator having suitable dimensions for use in connection with the present disclosure.

FIGS. 6A, 6B and 6C depict embodiments of BOV connectors according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, are systems, methods, and devices for dispensing maple syrup using a bag-on-valve delivery mechanism sometimes also referred to in the art as BOV. In such a system, the product to be dispensed is housed separately from the propellant that is used to dispense the product. This prevents pre-dispensation intermixing of the two components, improving taste, lengthening shelf life, and allowing the product to be sold as a 100% pure product, and allowing for more than 99% product utilization, reducing the waste found with both aerosolized dispensation systems and standard jarred or canned products.

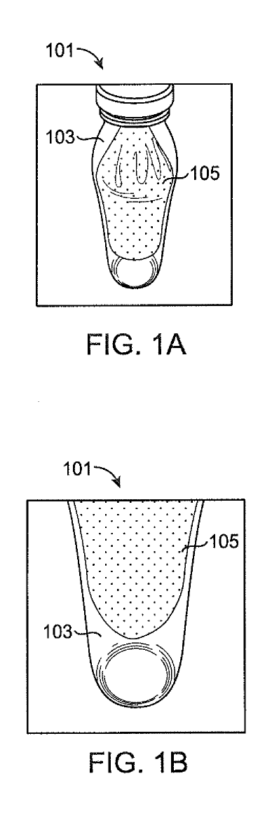

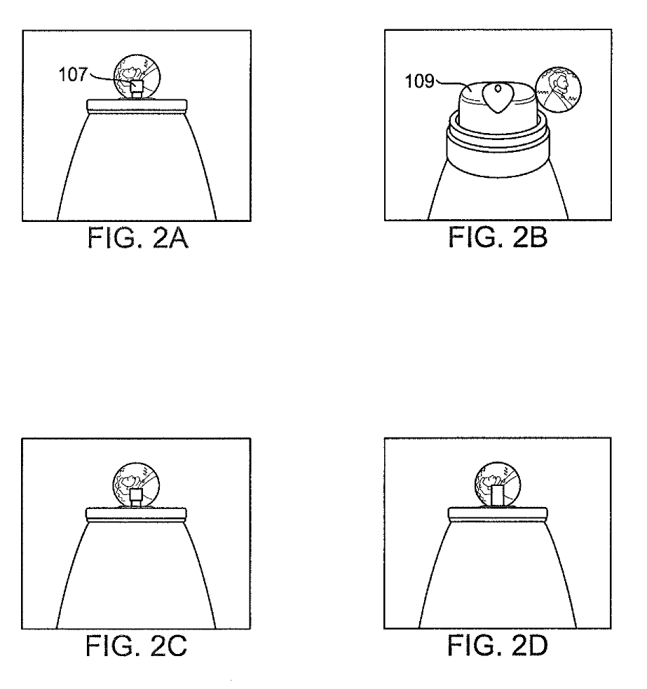

As described herein, the present systems and methods utilize a bag-on-valve mechanism for storing maple syrup in a physically separate compartment from the propellant, which is generally pressurized. In the depicted embodiment of FIGS. 1A-1B, a bag-on-valve 101 system is depicted showing a container 103 having a bag 105 of maple syrup therein. In an embodiment, a non-pressurized container may be used, relying on air to enter the container 103 and apply atmospheric pressure to the outside of the bag 105. In the depicted embodiment, the container 103 is pressurized to expel the contents of the bag 105. The BOV system is preferable, particularly for food products, because it inhibits the introduction of non-food propellant into the food substrate. Again, this allows the product to be advertised as 100% pure maple syrup and increases product utilization. Further, because the BOV 101 functions as a barrier to contamination by both atmospheric oxygen and bacteria, sugar crystallization, commonly observed in open containers, is also inhibited, extending the shelf life of the syrup. Because refrigeration is no longer necessary, it limits crystallization and achieves prolonged shelf life and inhibit bacterial growth, the BOV 101 system of FIGS. 1A-1B may be stored at room temperature. This also saves the consumer the additional step of heating the syrup before use.

Due to the high viscosity of maple syrup, dispensing it in a spray configuration is difficult, because maple syrup tends to crystalize upon oxidation, which can result in rapid clogging of a dispenser. The flow path must be large enough to facilitate syrup flow and storage in a liquefied state for weeks or months during non-use, and also allow room for some crystallization. This is because once the container has been used at least once, atmospheric oxygen will be introduced to the flow path, resulting in at least some crystallization. If the flow path is too small, it can crystalize sufficiently and clog, sometimes rendering the system unusable within a matter of days. However, a flow path that is too large will result in dispensing an undesirably large amount of syrup in a short amount of time. This results in both waste and accelerated consumption.

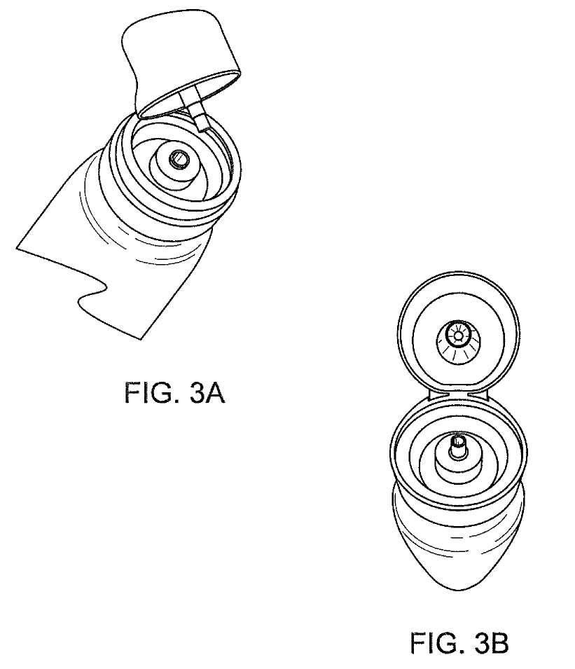

In the depicted BOV system, the syrup travels from the bag 105 through a valve stem 107 and through an actuator 109. Both the valve stem and actuator are preferably of adequate size to reduce the likelihood of crystallization during dispensation, while also facilitating a steady stream of syrup, rather than quickly dispensing a large volume. In the depicted embodiment of FIG. 3A a female valve/male actuator is shown. While this configuration is serviceable, in practice, the narrowed flow path of the syrup in such an embodiment encourages crystallization. In the depicted embodiment of 3B, a male valve/female actuator is shown. This is the preferred embodiment, as the larger flow path allows for a larger amount of crystallization before the system clogs to the point of no usability.

To address that issue, a high pressure container may be utilized to dislodge small syrup crystals blocking the flow path. In the event that even this is not sufficient to dislodge crystalized syrup in the flow path, the entire canister can simply be placed in a bowl of hot water, which will liquefy the crystalized syrup, generally within a few minutes, rendering the product functional again.

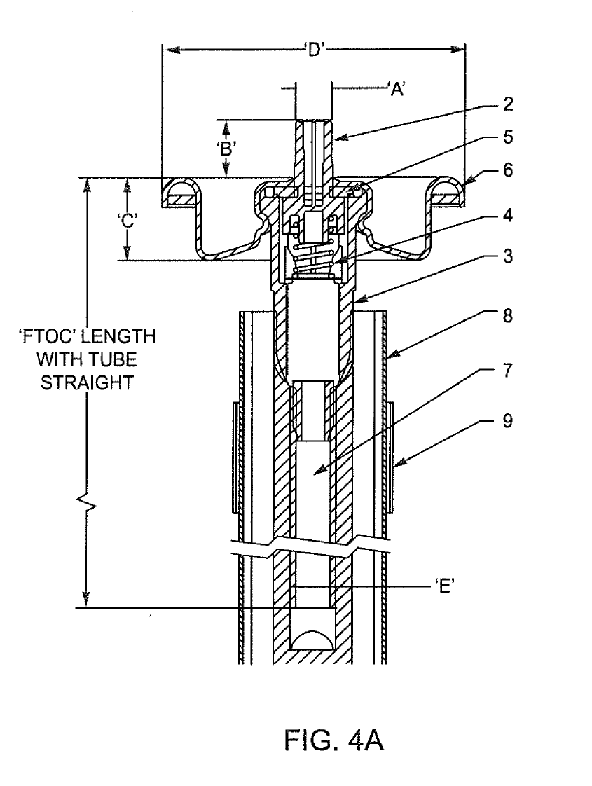

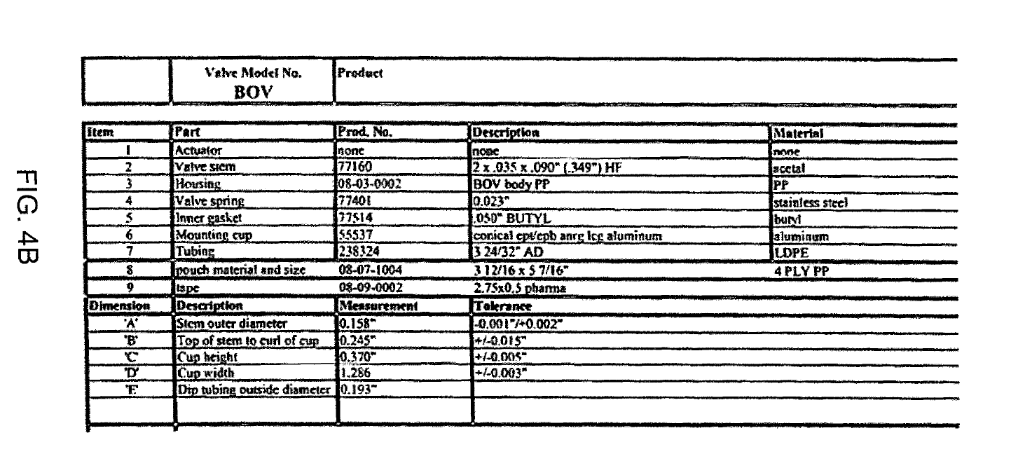

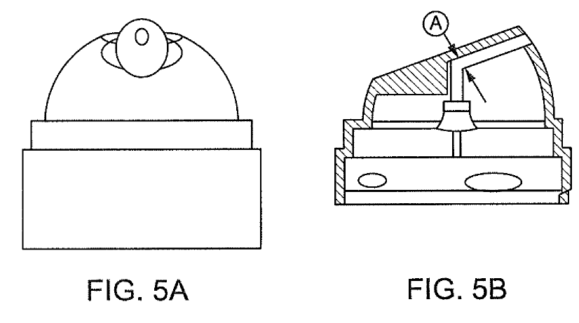

An exemplary embodiment of a BOV system having suitable dimensions for use in connection with the present disclosure is depicted in FIGS. 4A-4B. Similarly, an exemplary embodiment of an actuator having suitable dimensions for use in connection with the present disclosure is depicted in FIGS. 5A-5B. In the depicted embodiment of FIGS. 5A-5B, the actuator may be, for example, of a type manufactured by Summit Packaging Systems. By way of example and not limitation, the actuator flow path have may a diameter A of between about 0.30 millimeters to about 1.70 millimeters.

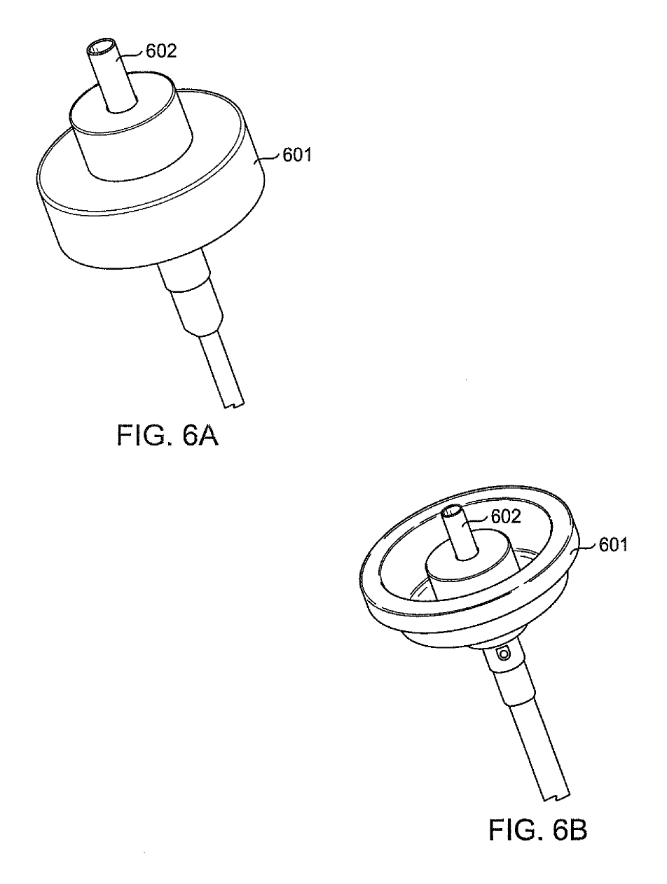

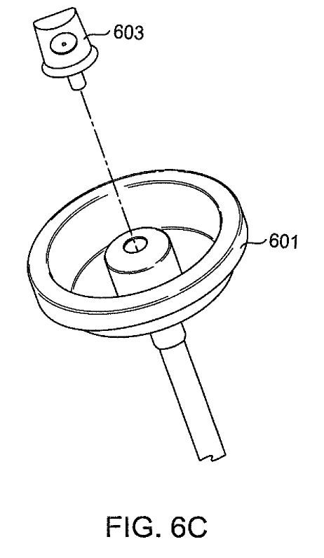

In an embodiment, the BOV system comprises a male BOV 601 such as that depicted in FIGS. 6A and 6B, paired with a female actuator. Preferably, a large-orifice actuator is used to inhibit clogging caused by the crystallization of sugars in the bagged fluid. However, it was discovered during the filling process, it often happens that a small drop of fluid remains in the stem 602 of the male BOV 601. If the filled device is not discharged within a sufficient amount of time before the actuator is applied, the fluid in the stem 602 will begin to crystallize and inhibit initial discharge once the actuator is attached. This in requires some cleaning effort prior to attaching the actuator, such as by cleaning in a sterilize bath to dislodge any accumulated product in the stem 602.

In an alternative embodiment, a female BOV 601 is used instead of a male BOV. Exemplary embodiments of female BOV couplers are depicted in FIG. 6C. Because female BOVs lack a stem, there is no channel to clog, and the crystallization problem is substantially mitigated. In such an embodiment, the female BOV 601 is preferably paired with a large-orifice male actuator 603, such as that depicted in FIG. 6C. The wider flow channel of a male actuator also further inhibits crystallization in the flow channel, lengthening the amount of time between uses before warming is needed.

Another common problem in the art is the cost and expense of sterilization. Prior practice for filling containers for dispensing viscous fluids like syrup or honey is to clean the containing vessel and sterilize both the container and fluid during packaging. This is generally done by heating both the container and fluid to a substantial temperature, such as 190° F. or more, to ensure sterility while filling the container. This wastes substantial energy in heating costs.

In an embodiment of the present systems, some of this cost is reduced or eliminated because the BOV is delivered sterile and no additional steps are needed to clean or sterilize. Further, since the filling process is a closed system without access to atmosphere, there is little to no risk of contamination. Filling containers in this fashion reduces time, energy, equipment, and labor costs.

The use of BOV components can, in some instances, require alternative filling processes from those known and used in the art. For example, in the filling process for male BOV components, a filling head connects with the stem of the male BOV to form a flow pathway or channel in fluid communication with a product source, through which product flows from the product source into the bag. The product flows through the stem into the BOV, and, when the filling head releases, typically a small amount of product remains in the stem.

In prior art BOV filling, this small quantity of fill product is benign and, typically, either e evaporates or is eliminated upon initial usage. However, for viscous liquids, such as a syrups and honeys, which tends to crystallize in the presence of oxygen, this stray quantity can clog the flow pathway prior to initial usage. To mitigate this clogging effect, an additional manufacturing step may be applied to clear the remnant fill product from the stem. This can be challenging in certain embodiments because the small diameter of the stem renders it difficult to access and remove viscous fluids. Additionally, the adhesive force between the stem and the product are relatively strong.

In an embodiment, the manufacturing includes a step of removing remnant fill product from the stem by the use of forceful introduction of water. This both dilutes and agitates to overcome the attractive forces between the stem and remnant. In an embodiment, the water may be heated. In another embodiment, the water (whether or not heated) may be injected into the stem. In still another embodiment, the water (whether or not heated), may be used as a bath.

By way of example and not limitation, a submersion process may be used by which finished cans are placed into a warm container of sanitizer followed by rigorous shaking to remove both the water and diluted syrup from the stem. This process may be done manually in small production runs, or automatically via machinery and/or robotic or computer-controlled apparatus designed for this purpose. In an embodiment, the finished cans are placed into the container stem-first. In another embodiment, a large water bath and a water agitator may be combined to provide both dilution and agitation. In another embodiment, water may be sprayed forcefully into the stem to further facilitate elimination.

In still another embodiment, dilution alone may be sufficient. By way of example and not limitation, the stem may be immersed in a liquid bath for a predetermined amount of time. The continued exposure via the open end of the step to the water in the both will eventually dilute the remnant due to the lower viscosity of the water. The appropriate amount of time for any particular stem/liquid combination may be determined using ordinary and typical experimentation. The amount of time should be effective to dilute the syrup to approximately the viscosity of water. The water can then evaporate, or be expelled upon first use of the product.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. An apparatus for dispensing a syrup comprising:
a container having an interior side and having an opposing exterior side;
a bag adapted to store syrup and having a fluid channel at an end thereof, said bag disposed in said hollow interior,
a fluid communication path from said bag to said exterior,
a valve disposed in said in fluid communication path, said valve having a closed position and an open position, said valve blocking said fluid communication path when in said closed position; and
an actuator operable to cause said valve stem to be in said open position;
wherein said fluid communication path has a diameter effective to inhibit syrup crystallization in said fluid communication path.

2. The apparatus of claim 1, wherein said diameter is more than about 0.30 millimeters.

3. The apparatus of claim 1, wherein said diameter is less than about 1.70 millimeters.

4. The apparatus of claim 1, further comprising a propellant disposed in said container between said bag and said interior side.

5. The apparatus of claim 1, wherein said valve comprises a male valve and said actuator comprises a female actuator.

6. The apparatus of claim 1, wherein said valve comprises a female valve and said actuator comprises a male actuator.

7. A method for filling a bag-on-valve container for dispensing viscous liquids comprising:
providing a bag-on-valve container system having a stem;
providing a source containing product to fill said bag-on-valve system;
providing a filling head adapted to fill said bag-on-valve system with product from said source;
said filling head forming, through said stem, a fluid pathway from said source to said bag-on-valve system;
filling said bag-on-valve system with product from said source through said formed fluid pathway;
releasing said filling head from said bag-on-valve system, said releasing step causing an amount of product remnant to deposit in said stem; and
removing said product remnant from said stem.

8. The method of claim 7, wherein said removing said product remnant from said stem comprises introducing a supply of water to said product remnant in said stem.

9. The method of claim 8, wherein said introducing a supply of water to said product remnant in said stem comprises disposing said filled bag-on-valve system in a water bath.

10. The method of claim 9, wherein said filled bag-on-valve system is disposed in said water bath stem first.

11. The method of claim 10, wherein said removing said product remnant from said stem further comprises removing said bag-on-valve system from said water bath after a predetermined amount of time.

12. The method of claim 11, wherein said predetermined amount of time is effective to dilute said product remnant to about the same viscosity as said water bath.

13. The method of claim 10, wherein said removing said product remnant from said stem further comprises agitating said filled bag-on-valve system after said removing step.

14. The method of claim 8, wherein said water is above room temperature.

15. The method of claim 8, wherein said introducing a supply of water to said product remnant in said stem comprises forceful injection of said water into said stem.

16. The method of claim 7, wherein said introducing a supply of water to said product remnant in said stem comprises immersing said stem in a water bath for a predetermined amount of time.

17. The method of claim 16, wherein said predetermined amount of time is effective to dilute said product remnant to about the same viscosity as said water bath.

18. The method of claim 16, wherein said predetermined amount of time is effective to dilute said product remnant to a viscosity at which said product does not crystallize sufficiently to clog said stem.

19. The method of claim 16, wherein said predetermined amount of time is effective to dilute said product remnant to a viscosity at which said product evaporates.

20. The method of claim 7, wherein said product comprises a honey or syrup.
